(19) United States
(12) Patent Application Publication
(10) Pub. No.: US 2012/0030478 A1
(43) Pub. Date: Feb. 2, 2012

(54) Dynamic Storage Enabler For Service Delivery HUB On A Mobility Network

(76) Inventors: David Dunmire, San Antonio, TX (US); Chad C. Keith, San Antonio, TX (US); Clifford Marcus Owenby, San Antonio, TX (US)

(21) Appl. No.: 12/847,635

(22) Filed: Jul. 30, 2010

(51) Int. Cl. G06F 15/173; H04L 9/00

(52) U.S. Cl. 713/189; 709/223

(57) ABSTRACT

A system includes a hub having interfaces to an application service provider and a portal in communication with an end user, a storage enabler connected to the hub, the storage enabler having application programming interfaces configured to receive a request for a storage facility from the application service provider and to allocate the storage facility based on the request for storage, and wherein the hub provides a single interface for the application service provider to request the storage facility when servicing the end user without regard to a location of the end user. The storage enabler is further configured to track data stored by one of the end user and the application service provider and to further provide encryption functionality.

### CROSS-RELATED UNITED STATES APPLICATIONS

This application is related to U.S. application Ser. Nos. 12/720,217, 12/720,277, and 12/720,300, all filed on Mar. 9, 2010 and assigned to the assignee of this application, each of which is hereby incorporated by reference in its entirety. This application is also related to United States patent applications entitled “METHOD FOR ENCRYPTING AND EMBEDDING INFORMATION IN A URL FOR CONTENT DELIVERY”, “ENABLERS FOR SERVICE DELIVERY HUB ON A MOBILITY NETWORK”, and “METHOD FOR AUTOMATING ONBOARDING OF USER GENERATED RINGBACK TONES TO SALES DISTRIBUTION CHANNEL” being filed concurrently herewith and assigned to the assignee of this application.

### TECHNICAL FIELD

This invention is directed to a service delivery platform, and more particularly, to a system, apparatus, and method for providing enabler services to third party application providers.

### BACKGROUND

In related application cited above, there was a disclosure that established an exemplary system and method for providing third party application service providers access to telecommunications services in order to exercise their respective business models. In that disclosure, there is disclosed a system and method in which a network operator may provide an environment for enabler providers to provide services to application service providers using the network operator's services and making such applications and services available to remote networks and users of those networks.

There is a need to expand the range of enabler services that are available to application service providers operating in a shared services environment.

### SUMMARY

The disclosure is directed to a hub having interfaces to an application service provider and a portal in communication with an end user and a storage enabler connected to the hub, the storage enabler having application programming interfaces configured to receive a request for a storage facility from the application service provider and to allocate the storage facility based on the request for storage, wherein the hub provides a single interface for the application service provider to request the storage facility when servicing the end user without regard to a location of the end user. The disclosure also includes wherein the storage enabler is further configured to track data stored by one of the end user and the application service provider, to provide encryption functionality to the stored data, and to allocate content from the end user when receiving the request using short codes.

### BRIEF DESCRIPTION OF THE DRAWINGS

The following description is better understood when read in conjunction with the appended drawings, wherein

FIG. 1 is a system diagram of a service delivery hub in communication with remote networks;

FIG. 2 is a block diagram illustrating the functions of the service delivery hub and the interfaces open to third parties;

FIG. 3 is a block diagram illustrating the routing control function of the service delivery hub;

FIG. 4 is a block diagram illustrating the accessing of an enabler through the service delivery hub by a third party; and

FIG. 5 is a block diagram illustrating an example of an architecture that illustrates the communications between a dynamic storage enabler, a hub, and an ASP.

### DETAILED DESCRIPTION OF ILLUSTRATIVE EMBODIMENTS

For the purposes of describing an exemplary embodiment of the invention, reference will be made to the figures set forth above and certain terms. As an aid to the reader, exemplary definitions of such terms are defined as follows:
“Application service provider (ASP)” is a provider which has one or more applications which employ the services of the service delivery hub.
“Aggregator” has relationships to one or more ASPs or developers and manages the access of the ASPs' respective applications to the service delivery hub.
“Enabler provider (EP)” develops services which may be incorporated into other applications, for example, a message enabler provider may provide access to WAP push, SMSC, and MMSC services as set forth below.
“On device” applications are applications that are downloadable to a device such as a mobile handset or smart phone.
“Web-hosted based” applications are applications which are sold in a subscription based model and accessed by customer devices.

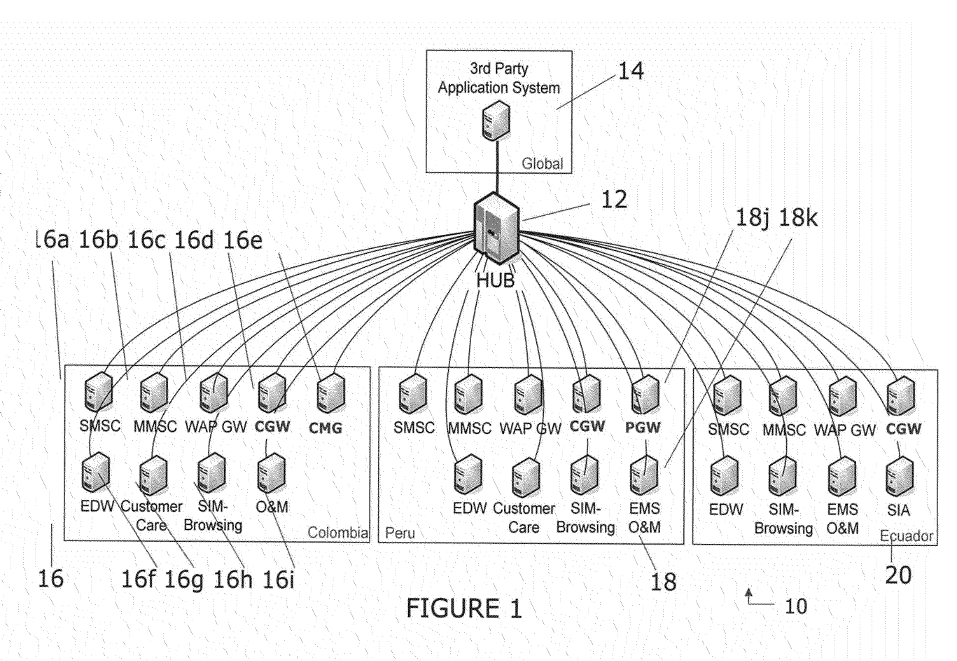

With reference to FIG. 1, there is shown a system 10 having a service delivery hub 12 in communication with network operations 16, 18, and 20. As described more fully herein, the service delivery hub 12 provides a central access point for third party ASPs, aggregators, and enabler providers and includes a set of application programming interfaces (API) provided by the network provider or other third parties. The service delivery hub 12 also includes a charging gateway which provides the capability for third parties to monetize their applications and a settlement center which balances accounts of multiple parties and network operators in accordance with contractual fee splitting arrangements or other mechanisms determined by the parties, so-called recursive settlements. The service delivery hub 12 also includes a control center to manage access to the system.

Referring again to FIG. 1, there is shown a third party application server 14 in communication with the service delivery hub 12. The service delivery hub 12 is targeted to produce an integration layer for access to the network operations 16, 18, and 20, specifically network elements, operational support systems and business support systems (OSS/BSS), and Internet application service providers (ASPs). The network operations 16, 18, and 20 (also referred to as networks herein) are illustrative only and could vary in number from one to many networks. The networks may be stand alone networks in a particular geographic area, which areas may be delineated on a country or state basis or any other geographic distinction. The networks may also be delineated by network operator or network type. There may also be more than one network in any one geographic region.

In the exemplary embodiment of FIG. 1, network operations 16 are designated as being in the country of Columbia, network operations 18 in Peru, and network operations 20 in Ecuador. Within each network operations 16, 18, 20, there is shown a representative sample of network subsystems contained therein and, in the case of network operations 16 in Columbia, shown numbered as 16a-16i. Those subsystems within network operations 16 include the short message service center (SMSC) 16a, multi-media service center (MMSC) 16b, wireless access protocol (WAP) gateway 16c, CMW 16d, CMG 16e, enterprise data warehouse (EDW) 16f, customer care 16g, subscriber interface module (SIM) browsing 16h, and operations and maintenance (O&M) 16i. It will be understood by those skilled in the art that not all subsystems are necessarily found in each network operations 16, 18, 20 and there may be other subsystems not listed above, for example, enterprise application integration (PGW) 18j, and emergency management systems (EMS) 18k are illustrated as part of network operation 18 but not as part of network operation 16.

The service delivery hub 12 exposes access to third party applications to network services provided by the network subsystems. The service delivery hub 12 supports third party developed services and controls application usage of network operations and third party services. It is preferred that the service delivery hub employ industry standards known to those skilled in the art or to be developed by the industry, including but not limited to Parlay X, SOAP, REST, HTTPS, JKD 1.5, XML, SSL+X509 certification for transport security, and WSSE username token profile security.

The service delivery hub 12, has interfaces into each of the subsystems within network operations 16, 18, 20. An exemplary methodology for using those interfaces may include establishing a VPN tunnel from the service delivery hub 12 to the subsystem of interest. Thus, if an application residing on the third party application system server 14 desires access to SMSC 16a, the service delivery hub 12 will establish a VPN tunnel or other connection to SMSC 16a thereby providing the application access to SMSC 16a.

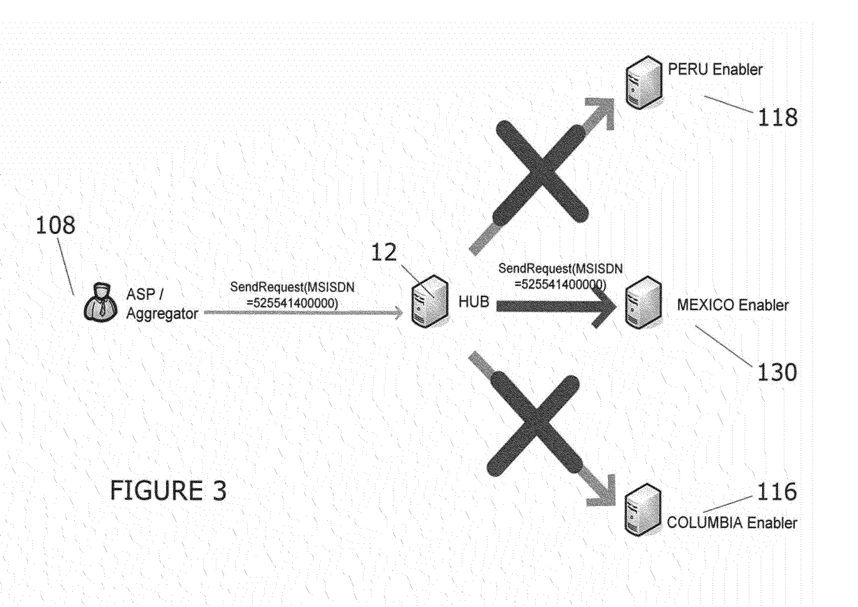

An example of this routing is shown in FIG. 3. In that example, an aggregator 108 is utilizing the service delivery hub 12 to access an enabler 130 located in Mexico through an API provided by enabler 130 and made available to aggregator 108 through service delivery hub 12. The aggregator will send a request message to the service delivery hub 12 which includes an identifier, in this case, a MSISDN. The service delivery hub 12 will interpret the MSISDN and determine that it is destined for enabler 130 located in Mexico and not for the enablers 116 and 118 located in Columbia and Peru, respectively. The service delivery hub 12 then establishes a VPN tunnel to the enabler 130 located in Mexico and will prevent access to other networks. This limited but direct access may be monetized by the enabler and the network operator.

The service delivery hub 12 operates based on a series of service level agreements (SLAs) between various parties and the network operator. The service delivery platform 12 encapsulates access to the network enablers, OSS/BSS enablers, application service provider (ASP) enablers and ASP applications. The service delivery platform 12 provides an application service creation gateway which provides standard APIs and software development kits (SDKs) to third party application providers. The service delivery hub 12 provides management functions for partners and aggregators, such as authentication, hosting, SLA policy control, service routing, limited charging, messaging, usage billing, settlement, monitoring, and reporting.

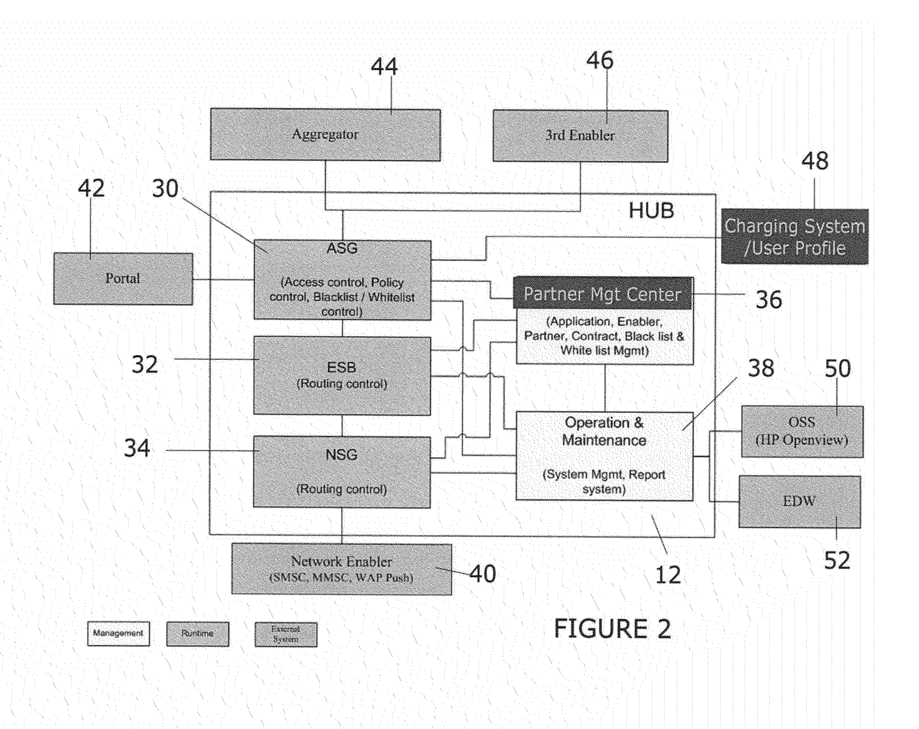

With reference to FIG. 2, an exemplary service delivery hub includes 12 functionality such as ASG 30, enterprise service bus (ESB) 32, network service gateway (NSG) 34, business manager (BLM) 36, and Operation & Maintenance 38. ASG 30 provides access control, policy control, and blacklist/whitelist control.

Portal 42 provides an external link which uses the ASG 30 functionality to control access to the service delivery hub and further to authenticate users. The portal function 42 of the service delivery hub 12 provides for the sales and distribution of content, including third party applications. Specific functionality may include device management and rendering, a recommendation engine, detailed application descriptions, product categorization, multi-language support, sales and revenue settlement reports, advertising associations and multi-network footprint.

The SRS/User Profile Server 48, shown in an exemplary embodiment as outside of service delivery hub 12 but interfacing therewith, provides storage media for user information and profiles and is accessible by the ASG function 30. Additional access and control interfaces are provided within the ASG function 30 for access by aggregators 44 and third party enablers 46.

The access control function within ASG 30 provides services such as service provider and user authentication and verification. The service level policy control function enables the service delivery hub 12 to control and, if necessary, limit the system resources available to an third party application to prevent system overloading. By controlling the system resources through the service delivery hub, the network resources are able to be allocated along a broad range of applications. Policy control also provides for monetization at the service level or the parameter level for access to all network enablers. The scarcity of or availability of resources depending on time of day and loading algorithms provide variable and cost effective price strategies to third party developers and enablers. Quality of service and pricing associated therewith may also be provided by the policy control function.

Routing control functionality is provided by enterprise service bus (ESB) 32. This includes developing or configuring the routing policy. The routing control functionality of the service delivery hub 12 enables the third party providers to interface with the network or multiple networks at one and only one access point. The service delivery hub 12 is preferably able to interpret the MSISDN to determine the local network operator involved in the transaction and route accordingly. For example, the ESB 32 may route based on MSISDN in a GSM environment. The routing may also be determined based on location, including country or market, or a sales portal catalog.

The network services gateway (NSG) 34 within the service delivery hub 12 interfaces with network enablers 40 to provide access to network functionality, including, for example, SMSC 16a, MMSC 16b, or WAP GW 16c or any other network elements or systems.

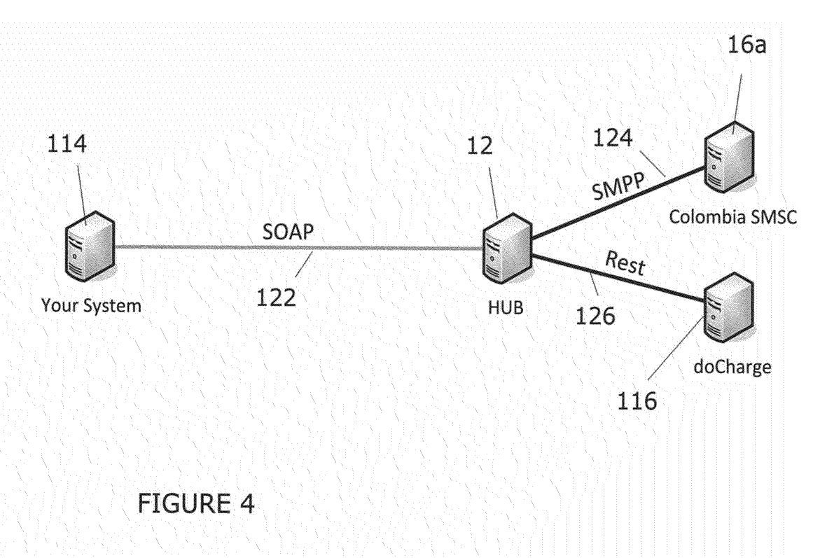

The service delivery hub 12 includes business management functions 36 which include the contracting capability between the network operators and the enabler providers and the network operators and the ASPs. The business management functions 36 include the ability to interface to a charging module, for example, the doCharge subsystem 116 in FIG. 4. In that example, a third party 114 may access the service delivery platform 12 using the SOAP protocol interface 122 to access the SMSC subsystem 16a located in Columbia under contract. The service delivery platform 12 will access the doCharge subsystem 116 for charging and reconciling the cost of such access to the third party (or its customers). From a third party's development standpoint, the third party system 114 will receive an API for the desired enabler, in this example, the SMSC 16a in Columbia. The third party would then develop the program using the API on the third party system 114 and test the program using the service delivery hub 12 test environment. Once development is completed, the third party system 114 will complete its purchase of access to the enabler and cut over to the production version of the service delivery hub 12.

Referring again to FIG. 2, the operations and maintenance functionality 38 of the service delivery hub 12 includes system management and reporting functions and provides interfaces to the operational support systems (OSS) 50 and electronic data warehouses (EDW) 52. The settlement functionality within the operations and maintenance functions 38 of the service delivery hub 12 provides allocation of revenue and reports covering various aspects of sales. This may include asset sales such as applications or enabler usage. Report features may include multi-currency and multi-country settlements. Moreover, there may be recursive settlement functionality for multi-party transactions. The reporting functionality within the operations and maintenance functions 38 of the service delivery hub 12 may be customized for a variety of applications and enablers. For example, reports may include application service provider settlements, application service provider traffic, enabler provider settlement, enabler provider traffic, traffic TPS reports, error, availability and sales portal reports.

The service delivery hub 12 provides the added functionality of monetization of third party applications and services. For example, the network enablers are provided the tools to be able to charge at the parameter level for access to all network enablers. Using the access control and other policy rules, third party enablers are able to throttle or gate applications based on TPS or total volume, time of day and other parameters. Moreover, the network operators may apply quality of service to the network-based APIs and third party supplied APIs.

With respect to third party enablers, the network operator may pay or revenue share for the use of such enablers. The network operator may sell access to the third party enablers. Finally, the network operator may recursively charge and settle with third party enablers.

In operation, the ASP may enter into a contractual relationship with a mobile network operator through which contract the network operator will provide functionality and interfaces using a set of SLA's to the ASP. The ASP incorporates the functionality into the application. The application is then either sold on the network operator's portal 42 (or multiple portals located in different geographic areas) or sold directly to the ASP.

Continuing with an operational view, an enabler, either a third party network enabler or a third party application enabler, may also enter into a contractual relationship with the mobile network operator. The enabler may provide a set of interfaces to the service delivery hub 12 on a revenue share basis to be used by third party ASPs using the service delivery hub 12.

There are many examples of this monetization business model. For example, application service providers utilizing the service delivery hub may contain products or services offered to the ASP's customers and include contractual terms with the network operator through which the network operator and the ASP both share in the monetization of an application. For example, video game developers may offer a gaming system to its customers on a storefront accessible through the portal 42 of the service delivery platform. The game may include, for example, a free trial version downloadable to a mobile device with an option to purchase the full version. The network operator will receive the order from the customer, deliver the full version of the game to the customer, receive payment from the customer, and then share the revenue generated with the ASP.

According to another exemplary utilization of the invention, an enabler may provide messaging services through an API that is made available to the ASP developing a video gaming application. For example, the enabler may offer two products to the ASP for a gaming application, sending and receiving SMS messages and sending and receiving MMS messages which permit users of the game to text or video chat while playing the game. For each, the ASP may charge its customers either a flat fee or a use-based fee or build the fee into the cost of the game. The network operator will bill and collect for the game from the customer. The network operator may charge the ASP a set-up fee, a maintenance fee, or a service-level based fee for use or a flat-rate fee for use, then pay the enabler a portion thereof for the use of the SMSC and MMSC subsystems, and then provide the remainder of the revenue from the customer to the ASP.

In another exemplary embodiment, an enabler may provide a service to the network operator on behalf of third party ASPs. For example, the enabler may provide mobile advertising services, including getting advertisements, posting advertisements and tracking advertisements. Depending on the contractual relationships, the parties involved in the transaction may share the advertising revenue either two ways, i.e., the enabler and network provider, or three ways, including the ASP.

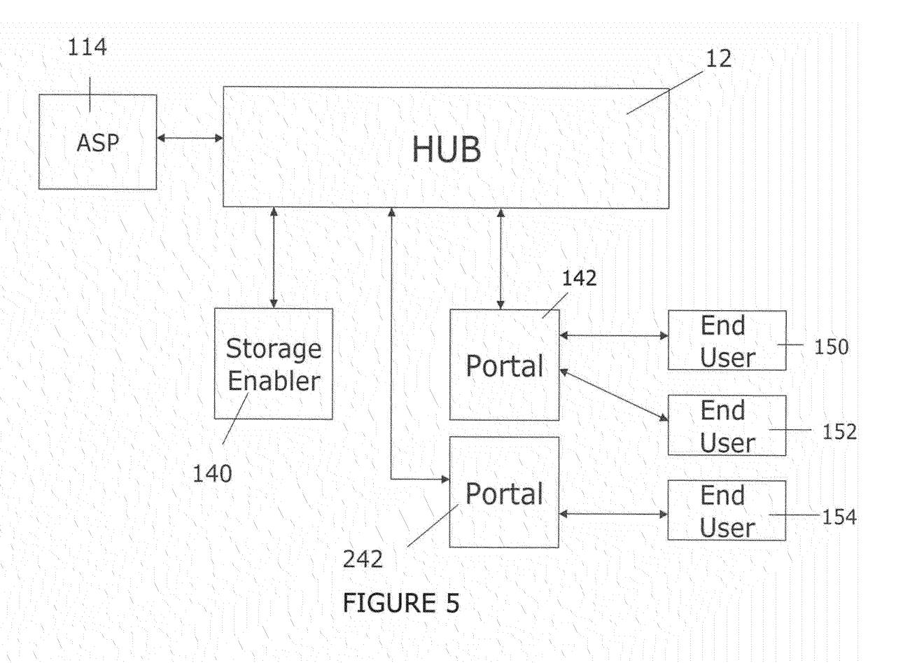

For example, in accordance with an embodiment of the disclosure, there may be an enabler directed to dynamic storage allocations provided by the network operator. The dynamic storage enabler 140 is shown in FIG. 5. The purpose of the dynamic storage enabler 140 is to provide a means by which third party ASPs may access a network operator's hosted storage repository for the purpose of storing user content for applications. The dynamic storage enabler 140 supplies features which may be needed by any application seeking to store customer data. The dynamic storage enabler 140 relieves the application from the burden of managing storage. The dynamic storage enabler 140 includes standard “Create,” “Update” and “Delete” functions which may be processed by the dynamic storage enabler 140 and not the application. The dynamic storage enabler 140 will also provide a standard set of retrieval and search APIs, as well as distribute to end users through the network operator's network. In addition, because the data search, storage, and retrieval functions will be standardized across application storage facilities, it may be possible for the network operator to use customer specific data in other products or services. The dynamic storage enabler 140 may be monetized by the network operator using the standard SLAs supported by the hub 12.

The hub 12 interfaces with one or more portals 142, 242 through which end users 150, 152, and 154 may access applications provided through the hub which may, for example, be an application provided by ASP 14. In the example of FIG. 5, end users 150, 152 access the hub through portal 142 while end user 154 accesses the hub 12 through portal 242. It will be understood that based on the hub architecture described herein, there is no requirement for the portals to be on the same network, nor is there a requirement for the ASP to be on the same network as either of the portals. The dynamic storage enabler 140 provides the ability to correlate diverse storage locations and methods for a single end user 150 into a single user repository, regardless of the network. The dynamic storage enabler also permits the application to access a single interface to access all user data.

Various features of the dynamic storage enabler 140 may be included. For example, the dynamic storage enabler 140 may provide an end user the ability to upload content through various channels for SMSC/MMSC using short codes. An application service provider may register a specific short code with the Dynamic Storage Enabler for this purpose. The dynamic storage enabler 140 may also allow an ASP to register a storage facility to use for an application's specific end customers. An advantage is that the mechanism by which this storage facility is accessed will remain constant for the ASP. The dynamic storage enabler 140 may store content metadata and upload the content to the ASP's registered storage facility and to search for such content metadata for other applications or content. The dynamic storage enabler 140 may support the optional encryption of content. The dynamic storage enabler 140 may provide the ability to distribute content upon demand by the ASP or by an end user to the end user using SMS, MMS, Wap Push, Email, or an API such as “Initiate Delivery.”

The dynamic storage enabler 140 may also provide an ability to collate common metadata across storage repositories for a specific end user. This includes collating content specific to a particular capability of a device being used by an end customer. The dynamic storage enabler 140 may provide an ability to set access level permissions for content. Finally, the dynamic storage enabler 140 may provide an ability to register alerts when events occur, such as adding, updating, retrieving, or deleting content.

In operation, the dynamic storage enabler may be utilized by one or more APIs. Example APIs may include, but are not limited to:
Register_storage_callback—Allows an ASP to designate a service to call each time the storage system is accessed.
Register_storage_system—Allows an ASP to register a storage locale.
Register_Shortcodes_for_Receipt—Allows an ASP to designate shortcodes to associate with standard storage processing commands provided by this enabler to end users.
GetProperties_of_Content—Allows an ASP to retrieve the metadata for a specific piece of content or group of content associated to an end user.
Update Content—Allows an ASP or end user (via a short code) to update content and content metadata.
GetContent—Allows an ASP or end user (via a short code) to retrieve content and content metadata.
DeleteContent—Allows an ASP or end user (via a short code) to delete content and content metadata
FindContent—Allows an ASP or end user (via a short code) to search for content and content metadata based upon keywords, devices, and personal identifiers.
PutContent—Allows an ASP or end user (via a short code) to add new content and content metadata to the storage repository
AssignAccessToContent—Allows an ASP or end user (via a short code) to grant other users access to content
GetAssociatedApplicationsbyDevice—Allows an ASP or end user (via a short code) to determine which applications on a specific device can present a piece of content to an end user's device
SendNotifications—Allows an ASP to initiate notifications of events associated to content maintenance.
DeliverContent—Allows an ASP or end user (via a short code) to distribute content and content metadata
Register_AuthCallback—Allows an ASP to indicate the service which should be checked in order to determine if content is authorized for distribution.

While the dynamic storage enabler within the service delivery hub has been described in connection with the various embodiments of the various figures, it is to be understood that other similar embodiments can be used or modifications and additions can be made to the described embodiment for performing the same types of functionality in service delivery without deviating therefrom. While the enabler has been described for use in an exemplary hub environment, other environments are contemplated, including self-contained networks. Any type of telecommunications network may be supported, including but not limited to GSM, CDMA, EDGE, 3G, 4G, LTE or any other wireless network and may also interface and provide access to wired networks, including the internet. Therefore, the dynamic storage enabler should not be limited to any single embodiment, but rather should be construed in breadth and scope in accordance with the appended claims.

What is claimed:

1. A system comprising:
a hub having interfaces to an application service provider and a portal in communication with an end user;
a storage enabler connected to the hub, the storage enabler having application programming interfaces configured to receive a request for a storage facility from the application service provider and to allocate the storage facility based on the request for storage; and
wherein the hub provides a single interface for the application service provider to request the storage facility when servicing the end user without regard to a location of the end user.

2. The system of claim 1 wherein the storage enabler is further configured to track data stored by one of the end user and the application service provider.

3. The system of claim 1 wherein the storage enabler is further configured to provide encryption to stored data.

4. The system of claim 1 wherein the storage enabler is further configured to allocate storage for content received from the end user when receiving the request using short codes.

5. A system comprising:
a hub having interfaces to an application service provider and a portal in communication with an end user;
a storage enabler connected to the hub, the storage enabler having application programming interfaces configured to receive a request for a storage facility from the application service provider and to allocate the storage facility based on the request for storage; and
wherein the hub provides a single interface for the end user to request the storage facility for use with the application service provider.

6. The system of claim 5 wherein the end user requests the storage facility for use with a plurality of application service providers.

7. The system of claim 6 wherein the plurality of application service providers track the storage facility requested by the end user.

8. The system of claim 5 wherein the storage enabler is further configured to provide encryption to stored data.

9. The system of claim 5 wherein the storage enabler is further configured to allocate storage for content received from the end user when receiving the request using short codes.
